(19) United States
(12) Patent Application Publication
(10) Pub. No.: US 2026/0095686 A1
(43) Pub. Date: Apr. 2, 2026

(54) CELLULAR CAPABILITY CONTROL OF A WIRELESS EARBUDS CASE BASED ON WIRELESS CONNECTION TO AN EXTERNAL DEVICE

(71) Applicant: Motorola Mobility LLC, Chicago, IL (US)

(72) Inventors: Xuyuan Pan, Chicago, IL (US); Daniel C. Chisu, Franklin Park, IL (US); Junsheng Zhao, Vernon Hills, IL (US); Md Faisal Abedin, Lisle, IL (US)

(73) Assignee: Motorola Mobility LLC, Chicago, IL (US)

(21) Appl. No.: 18/899,270

(22) Filed: Sep. 27, 2024

(51) Int. Cl. H04R 1/02

(52) U.S. Cl. CPC H04R 1/02

(57) ABSTRACT

In accordance with the described techniques, a system includes a mobile device, a pair of wireless earbuds, and an earbuds case configured for housing the pair of wireless earbuds. The earbuds case includes a controller and a communication system configured for wireless communication with a cellular network. The controller detects a connection state of the wireless earbuds indicating whether the wireless earbuds are wirelessly connected to the mobile device and whether the wireless earbuds are wirelessly connected to the earbuds case. Based on the connection state, the controller updates a configuration of the communication system to modulate a wireless cellular communication capability of the communication system.

### BACKGROUND

True wireless earbuds are a type of earbuds that operate without any physical connection between the left and right earbuds or to an audio source. In particular, true wireless earbuds utilize wireless connectivity (e.g., a Bluetooth connection) for wireless communication, allowing users to enjoy music, calls, and other audio without the hassle of wires. True wireless earbuds have gained popularity due to their convenience and portability. As true wireless earbud technology advances, the features of true wireless earbuds also advance, including improved noise cancellation, implementation of touch controls, voice assistant integration, and enhanced battery life. A pair of true wireless earbuds typically comes with an earbuds case that houses and charges the pair of true wireless earbuds to extend earbud battery life.

### BRIEF DESCRIPTION OF THE DRAWINGS

Aspects of cellular capability control of a wireless earbuds case based on wireless connection to an external device are described with reference to the following Figures. The same numbers may be used throughout to reference similar features and components that are shown in the Figures. Further, identical numbers followed by different letters reference different instances of features and components described herein.

FIG. 1 illustrates an example environment in which aspects of cellular capability control of a wireless earbuds case based on wireless connection to an external device can be implemented;

FIG. 2 illustrates an example system for cellular capability control of a wireless earbuds case based on wireless connection to an external device;

FIG. 3 depicts an example system for cellular capability control of a wireless earbuds case based on a physical arrangement of the wireless earbuds case and wireless earbuds;

FIG. 4 depicts an example showing manners in which a controller of a wireless earbuds case modulates wireless cellular communication capabilities of the wireless earbuds case;

FIG. 5 illustrates a flow chart depicting an example method of cellular capability control of a wireless earbuds case based on wireless connection to an external device

FIG. 6 illustrates a flow chart depicting an example method of cellular capability control of a wireless earbuds case based on wireless connection to an external device to restore a wireless cellular capability of the earbuds case based on quality of service deliverable by the earbuds case and the external device;

FIG. 7 illustrates a flow chart depicting an example method of cellular capability control of a wireless earbuds case based on a physical arrangement of the wireless earbuds case and wireless earbuds;

FIG. 8 illustrates various components of an example device in which aspects of the described techniques can be implemented.

FIG. 9 illustrates various components of an example device in which aspects of the described techniques can be implemented.

### DETAILED DESCRIPTION

Cellular capability control of a wireless earbuds case is discussed herein. Generally, the techniques discussed herein are directed to an earbuds case configured for housing a pair of wireless earbuds. Unlike conventional cases for true wireless earbuds, the earbuds case is configured for wireless communication with a cellular network. For example, the earbuds case includes a communication system having a subscriber identity module (SIM) chip, a modem (e.g., a modulator-demodulator), a radio frequency (RF) front end, an antenna system having multiple cellular antennas (e.g., radio frequency (RF) antennas operating in frequency bands used by cellular networks, such as 3G, 4G LTE, and 5G), and/or additional circuitry facilitating cellular network connectivity.

Thus, in accordance with the described techniques, the circuitry components of the earbuds case are more densely arranged than conventional earbuds cases in order to accommodate the additional circuitry of the communication system while maintaining a small form factor. However, such a dense circuitry arrangement leads to increased thermal activity in the earbuds case, e.g., due to increase heat generation in a compact area as well as a lack of airflow and thermal isolation between circuitry components. Increased thermal activity also accelerates chemical reactions in a battery of the earbuds case which can reduce battery performance by reducing battery capacity, increasing a rate of battery drainage, and increasing a rate of battery degradation, e.g., shortening battery lifespan. To decrease thermal activity and improve battery performance, techniques are described herein to reduce cellular communication capabilities of the communication system in response to detecting usage scenarios in which a user is not utilizing the cellular communication capabilities of the earbuds case.

One such technique includes controlling a cellular communication capability of the earbuds case based on the existence of a wireless (e.g., Bluetooth) connection between the wireless earbuds and an external device. In accordance with the described techniques, the wireless earbuds are wirelessly connectable to the earbuds case and a mobile device, e.g., using Bluetooth antennas. Here, a controller of the earbuds case receives wireless connection data from the mobile device or the wireless earbuds indicating whether the wireless earbuds are wirelessly connected to the mobile device. In addition, the controller receives wireless connection data from the communication system indicating whether the wireless earbuds are wirelessly connected to the earbuds case. Based on the wireless connection data, the controller detects a first connection state in which the wireless earbuds are wirelessly connected to the mobile device, or a second connection state in which the wireless earbuds are wirelessly connected to the earbuds case and wirelessly disconnected from the mobile device.

In one or more implementations, the controller detects a transition from the second connection state to the first connection state. This transition is indicative of the user of the true wireless earbuds not utilizing (e.g., not needing) the wireless cellular communication functionality of the earbuds case. This is because wireless cellular communication functionality is deliverable by the mobile device via the wireless connection between the wireless earbuds and the mobile device. Thus, in response to detecting the transition, the controller updates a configuration of the communication system from a second configuration associated with the second connection state to a first configuration associated with the first connection state. As part of updating the configuration, the controller reduces a cellular communication capability of the earbuds case.

Another technique for decreasing thermal impact and improving battery performance of the earbuds case based on usage includes controlling cellular communication capability of the earbuds case based on a physical arrangement of the earbuds case and the wireless earbuds. In accordance with the described techniques, the earbuds case includes a first housing (e.g., a base), a second housing (e.g., a lid), and a hinge coupling the base to the lid. The hinge enables the base and the lid to pivot or rotate about the hinge relative to one another between an open position and a closed position. The wireless earbuds include sensors for detecting whether the wireless earbuds are inserted in ears of a user. In addition, the earbuds case includes sensors for detecting whether the earbuds case is in the open position or the closed position, and sensors for detecting whether the wireless earbuds are inserted in the earbuds case.

Here, the controller of the earbuds case receives sensor data from the aforementioned sensors of the wireless earbuds and the earbuds case. Based on the sensor data, the controller determines one of three arrangement states—a first arrangement state in which the wireless earbuds are inserted in the earbuds case and the earbuds case is in the closed position, a second arrangement state in which the earbuds case is in the open position and the wireless earbuds are removed from the earbuds case, and a third arrangement state in which the wireless earbuds are inserted in the ears of the user. In one or more implementations, the controller detects a first transition from the third arrangement state to the second arrangement state, or a second transition from the second arrangement state to the first arrangement state. Notably, the different arrangement states are indicative of different degrees of usage of the wireless earbuds. For instance, the first arrangement state indicates that a user is not using the wireless earbuds, the second arrangement state indicates that the user is transitioning to using the wireless earbuds, while the third arrangement state indicates that the user is actively using the wireless earbuds.

Given this, the controller is configured to update the configuration of the communication system in response to detecting the first transition or the second transition. Responsive to detecting the first transition, the controller updates a configuration of the communication system from a third configuration associated with the third arrangement state to a second configuration associated with the second arrangement state. In response to detecting the second transition, the controller updates the configuration of the communication system from the second configuration associated with the second arrangement state to a first configuration associated with the first arrangement state. As part of updating the configuration responsive to the first transition or the second transition, the controller reduces a cellular communication capability of the earbuds case.

Updating the configuration of the communication system to reduce cellular communication capability is performable in various manners, examples of which include reducing a power state of the modem, deactivating one or more cellular antennas of the antenna system, reducing a transmit power class of one or more circuitry components of the communication system, reducing an RF bandwidth at which the communication system receives and transmits cellular data, reducing a radio access technology (RAT) by which the communication system receives and transmits cellular data, updating a carrier aggregation to reduce one or more component carriers at which the communication system receives and transmits cellular data, and/or reducing a Radio Resource Control (RRC) connection state of the communication system. Each of these example operations reduce activity in the communication system which reduces thermal activity and improves battery performance in the earbuds case.

Thus, the described techniques detect usage scenarios in which the user of the wireless earbuds and/or earbuds case is not using and/or does not need the wireless cellular communication functionality of the earbuds case. In these scenarios, the described techniques update a configuration of the communication system of the earbuds case to reduce a cellular communication capability of the communication system. In doing so, the described techniques reduce thermal activity in the earbuds case, increase battery capacity, reduce a rate of battery drainage, and reduce a rate of battery degradation, e.g., increasing battery lifespan.

While features and concepts of cellular capability control of a wireless earbuds case based on wireless connection to an external device can be implemented in any number of environments and/or configurations, aspects of the described techniques are described in the context of the following example systems, devices, and methods. Further, the systems, devices, and methods described herein are interchangeable in various ways to provide for a wide variety of implementations and operational scenarios.

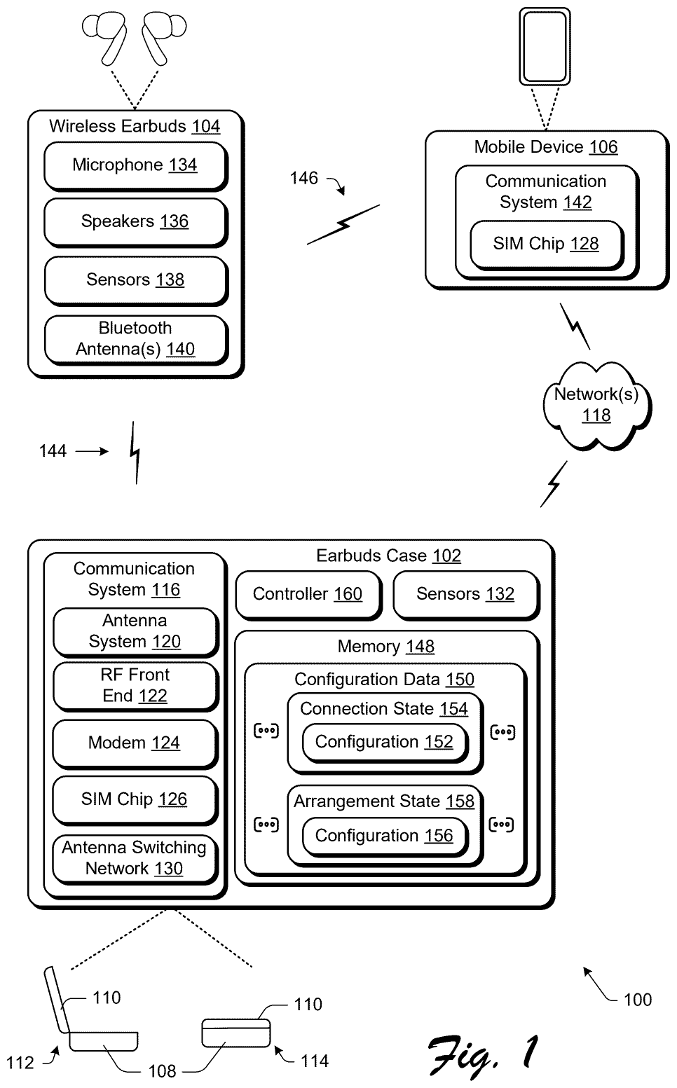

FIG. 1 illustrates an example environment 100 in which aspects of cellular capability control of a wireless earbuds case based on wireless connection to an external device can be implemented. The environment 100 includes an earbuds case 102, a pair of wireless earbuds 104 (e.g., true wireless earbuds), and a mobile device 106. As shown, the earbuds case 102 includes a first housing configured as a base 108 of the earbuds case 102, and a second housing configured as a lid 110 of the earbuds case 102. Although not illustrated, the earbuds case 102 includes a hinge coupling the base 108 to the lid 110. The hinge enables the base 108 and the lid 110 to pivot or rotate about the hinge relative to one another between an open position and a closed position. A side view of a non-limiting example earbuds case in the open position is illustrated at 112, while a side view of the non-limiting example earbuds case in the closed position is depicted at 114. Generally, the earbuds case 102 is configured to house the wireless earbuds 104. For example, the base 108 and/or the lid 110 include two cavities conforming to the shape of the pair of wireless earbuds 104, such that the earbuds 104 are insertable into the cavities when the earbuds case 102 is in the open position. Moreover, the wireless earbuds case 102 is configured to enclose the earbuds 104 when the earbuds 104 are inserted in the earbuds case 102 that is arranged in the closed position. Although not shown, the earbuds case 102 includes a battery and a charging circuit which electrically connects to the wireless earbuds 104 when they are inserted in the earbuds case 102 to enable the battery to charge the wireless earbuds 104.

As shown, the earbuds case 102 includes a communication system 116 which is generally configured to enable wireless connectivity with one or more networks 118 (e.g., cellular networks and Wi-Fi networks) and other devices, e.g., the wireless earbuds 104. To enable network and inter-device connectivity, the communication system 116 includes an antenna system 120, which includes any one or more of various types of antennas. Example antennas of the antenna system 120 include, but are not limited to including, ultra-wideband (UWB) antennas, Wi-Fi antennas (e.g., radio frequency (RF) antennas operating in frequency bands used by Wi-Fi networks), Bluetooth antennas, cellular antennas (e.g., RF antennas operating in frequency bands used by cellular networks, such as 3G, 4G LTE, and 5G cellular networks), and global positioning system (GPS) antennas. In at least one example, the antenna system 120 includes a cellular antenna within the base 108 of the earbuds case 102, and an additional cellular antenna within the lid 110 of the earbuds case 102.

The communication system 116 is further illustrated as including a radio frequency (RF) front end 122, which is implemented in electronic circuitry to process RF signals. More specifically, the RF front end 122 processes RF signals received by an antenna (e.g., a Wi-Fi antenna or a cellular antenna) of the antenna system 120, filters out unwanted frequencies, amplifies desired frequencies (e.g., using a low-noise amplifier), and down-converts the received RF signals to baseband signals in a baseband frequency. In addition, the RF front end 122 processes baseband signals, up-converts them to the desired RF frequency, amplifies the signals (e.g., using a power amplifier), filters out unwanted frequencies, and then transmits the signal using the antenna, e.g., a Wi-Fi antenna or cellular antenna. Notably, baseband signals are unmodulated signals containing the actual data (e.g., audio, text, and/or digital data) being transmitted or received.

Moreover, the communication system 116 includes a modem 124 (e.g., a modulator-demodulator), which is implemented in electronic circuitry to modulate digital signals and demodulate analog signals. More specifically, the modem 124 converts (e.g., modulates) digital data to be transmitted over the network(s) 118 to RF signals that are communicable over the wireless network(s) 118, e.g., Wi-Fi networks and cellular networks. Furthermore, the modem 124 converts (e.g., demodulates) RF signals received from wireless network(s) 118 (e.g., Wi-Fi networks and cellular networks) to digital data processable by digital circuitry of the earbuds case 102.

The communication system 116 is illustrated as including a subscriber identity module (SIM) chip 126, and the mobile device 106 is illustrated as including a SIM chip 128. In variations, the SIM chips 126, 128 are removable SIM chips (e.g., capable of being physically inserted and removed from the earbuds case 102 and mobile device 106, respectively) or embedded SIM (eSIM) chips, e.g., embedded in hardware of the earbuds case 102 and mobile device 106, respectively. Generally, the SIM chips 126, 128 are configured to store one or more SIM profiles, which enable provision of services from a cellular network operator to the earbuds case 102 and the mobile device 106. For example, a SIM profile includes an international mobile subscriber identity (IMSI) number which uniquely identifies a subscriber to the cellular network operator, security keys, and service plan information, e.g., a phone number associated with the user/subscriber. When a device (e.g., the earbuds case 102 and/or the mobile device 106) connects to the cellular network, the cellular network authenticates the user as a subscriber using the IMSI and the security keys in the SIM profile. This enables the device (e.g., the earbuds case 102 and/or the mobile device 106) to access the cellular network, including the ability to make calls and send/receive short message service (SMS) text messages using the phone number in the SIM profile. In one or more implementations, the earbuds case 102 and the mobile device 106 are configured with multi-SIM functionality, thereby enabling both the earbuds case 102 and the mobile device 106 to make calls and send/receive SMS texts using the same SIM profile/phone number.

The communication system 116 also includes an antenna switching network 130, which is a system implemented in digital circuitry to dynamically deactivate and activate antennas of the antenna system 120. By way of example, the antenna switching network 130 dynamically switches between different combinations of active antennas in the antenna system 120 that are actively receiving and transmitting signals. As mentioned above, the earbuds case 102 includes a first cellular antenna in the base 108 and a second cellular antenna in the lid 110 in various implementations. Thus, in usage scenarios in which the cellular communication functionality of the earbuds case 102 is not being used, the antenna switching network 130 is configured to reduce cellular communication capability of the communication system 116 by deactivating one or both of the cellular antennas, e.g., to conserve battery and reduce thermal impact of the communication system 116 to prevent overheating. Similarly, in usage scenarios in which the cellular communication functionality of the earbuds case 102 is being used, the antenna switching network 130 increases cellular communication capability of the communication system 116 by activating one or both of the cellular antennas.

As shown, the earbuds case 102 additionally includes sensors 132, examples of which include motion sensors (e.g., a gyrometer and an accelerometer) and touch sensors. In accordance with the described techniques, the sensors 132 include an insertion sensor, which is configured to detect whether the earbuds 104 are inserted in the earbuds case 102. In addition, the sensors 132 include a positional sensor, which is configured to detect whether the earbuds case 102 is in the open position or the closed position. Examples of the insertion sensor and the positional sensor include Hall Effect Sensors, capacitive proximity sensors, optical sensors, and mechanical switches.

The wireless earbuds 104 include at least one microphone 134 that enables input of audio (e.g., voice) data via the wireless earbuds 104. In addition, the wireless earbuds 104 include one or more speakers 136 (e.g., at least one speaker per earbud 104) enabling output of audio data via the wireless earbuds 104. Furthermore, the wireless earbuds 104 include sensors 138, examples of which include touch sensors and motion sensors, e.g., accelerometers and gyroscopes. In accordance with the described techniques, the sensors 138 include insertion sensors (e.g., at least one per earbud 104) configured to detect whether the earbuds 104 are inserted in ears of a user. Examples of the insertion sensors include proximity sensors, touch sensors, and optical sensors. Moreover, the wireless earbuds 104 are illustrated as including one or more Bluetooth antennas 140, which enable short-range wireless communication of data between additional devices (e.g., the earbuds case 102 and the mobile device 106) and the wireless earbuds 104.

In the illustrated example, the mobile device 106 is a smartphone. However, this example is not to be construed as limiting. Rather, the mobile device 106 is configurable in a variety of ways, examples of which include a laptop computer, a tablet device, and/or any other type of electronic or communication device. As shown, the mobile device 106 includes a communication system 142 which is generally configured to enable wireless connectivity with one or more networks 118 (e.g., cellular networks and Wi-Fi networks) or other devices, e.g., the wireless earbuds 104. The communication system 142 of the mobile device 106 is configured similarly to the communication system 116 of the earbuds case 102. For example, although not shown, the communication system 142 includes an antenna system, an RF front end, the SIM chip 126, an antenna switching network, and/or any one or more additional components used in a process for receiving and/or transmitting data between one or more devices and/or networks 118.

In one or more implementations, the earbuds case 102 and the wireless earbuds 104 are communicatively coupled via a peer-to-peer connection 144. By way of example, the Bluetooth antenna(s) of the antenna system 120 and the Bluetooth antenna(s) 140 of the wireless earbuds 104 facilitate short-range wireless communication of data between the earbuds case 102 and the wireless earbuds 104 via a Bluetooth connection or Bluetooth Low Energy (BLE) connection. Additionally or alternatively, the mobile device 106 and the wireless earbuds 104 are communicatively coupled via a peer-to-peer connection 146. For example, the Bluetooth antenna(s) of the communication system 142 and the Bluetooth antenna(s) 140 of the wireless earbuds 104 facilitate short-range wireless communication of data between the mobile device 106 and the wireless earbuds 104 via a Bluetooth connection or Bluetooth Low Energy (BLE) connection. Moreover, the earbuds case 102 and the mobile device 106 are equipped with wireless cellular communication capabilities to transmit and receive data over a cellular network, while the wireless earbuds 104 are not equipped with such cellular communication capabilities.

Given this, in order to receive wireless cellular communications (e.g., voice calls and/or SMS messages), the wireless earbuds 104 receive the cellular communication via the peer-to-peer connection 144 with the earbuds case 102 or the peer-to-peer connection 146 with the mobile device 106. When the wireless earbuds 104 are connected to the mobile device 106, for instance, the mobile device 106 receives a cellular communication and communicates data (e.g., audio data) of the cellular communication via the peer-to-peer connection 146 for output by the speakers 136. Contrarily, when the wireless earbuds 104 are connected to the earbuds case 102, the earbuds case 102 receives a cellular communication and communicates data (e.g., audio data) of the cellular communication via the peer-to-peer connection 144 for output by the speakers 136.

Conventional earbuds cases are not equipped with wireless cellular communication capabilities. For example, conventional earbuds cases do not include cellular antennas, an RF front end 122, a modem 124, a SIM chip 126, and/or an antenna switching network 130. To accommodate the additional circuitry components of the communication system 116, the circuitry components of the earbuds case 102 are more densely arranged than conventional earbuds cases in order to maintain a small form factor. However, such a dense circuitry arrangement leads to increased thermal activity. By way of example, a tight or dense packing of circuitry components leads to more heat generation in a smaller area as well as a lack of airflow and thermal isolation between circuitry components. Increased thermal activity also negatively impacts battery performance of the earbuds case 102. Indeed, heat accelerates chemical reactions inside the battery which can cause reduced battery capacity, increased rate of battery drainage, and increased rate of battery degradation, e.g., shortening battery lifespan.

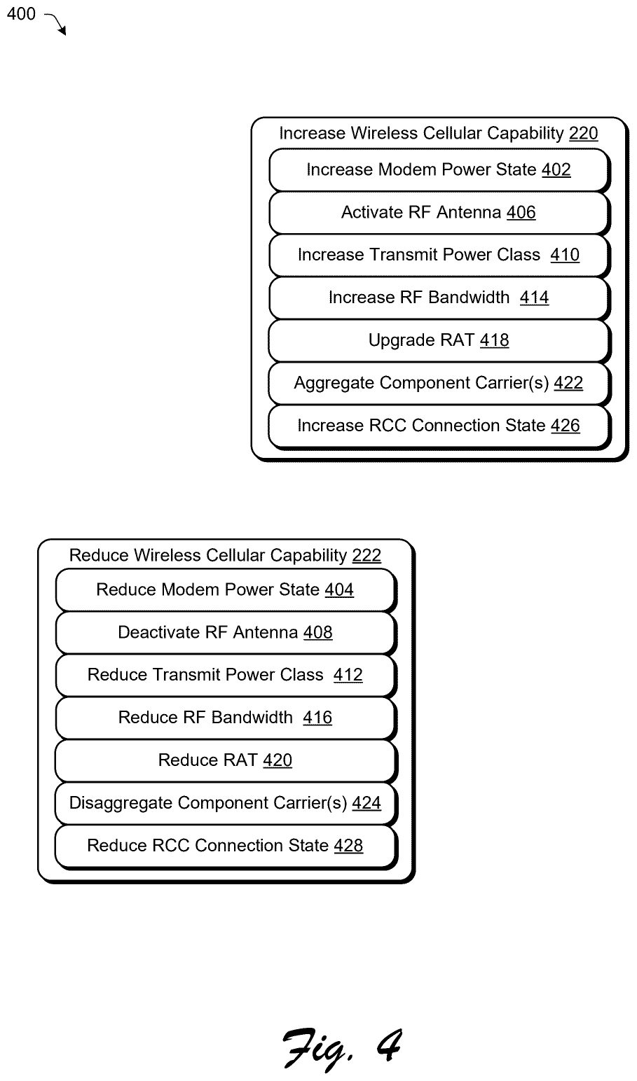

To decrease thermal activity and improve battery performance, techniques are described herein to reduce cellular communication capabilities of the communication system 116 in response to detecting usage scenarios in which the cellular communication functionality of the earbuds case 102 is not utilized and/or needed by a user of the wireless earbuds 104 and/or earbuds case 102. Reducing cellular communication capabilities reduces thermal activity in the communication system 116, which in turn, reduces thermal activity in the earbuds case 102 as a whole, improves battery performance, and extends battery life. Examples of how the cellular communication capability of the communication system 116 is modulated are further described below with reference to FIG. 4.

As part of this, the earbuds case 102 includes a memory 148 storing configuration data 150. As shown, the configuration data 150 includes different configurations 152 of the communication system 116 for different connection states 154 of the wireless earbuds 104. Furthermore, the configuration data 150 includes different configurations 156 of the communication system 116 for different arrangement states 158 of the wireless earbuds 104 and the wireless earbuds case 102. Notably, the different connection states 154 indicate whether the wireless earbuds 104 are wirelessly connected to the earbuds case 102 via the peer-to-peer connection 144, and whether the wireless earbuds 104 are connected to the mobile device 106 via the peer-to-peer connection 146. Furthermore, the different arrangement states 158 indicate whether the earbuds case 102 is in the open position or the closed position, and whether the wireless earbuds 104 are inserted in the earbuds case 102 or ears of a user. As further discussed below with reference to FIG. 4, the different configurations 152, 156 include different power states of the modem 124, different combinations of active (cellular) antennas of the antenna system 120, different transmit power classes for different circuitry components of the communication system 116, different RF bandwidths at which the communication system 116 receives and transmits cellular data, different radio access technologies (RATs) and different versions thereof by which the communication system 116 transmits and receives cellular data, different carrier aggregations of the communication system 116, and different Radio Resource Control (RRC) connection states of the communication system 116.

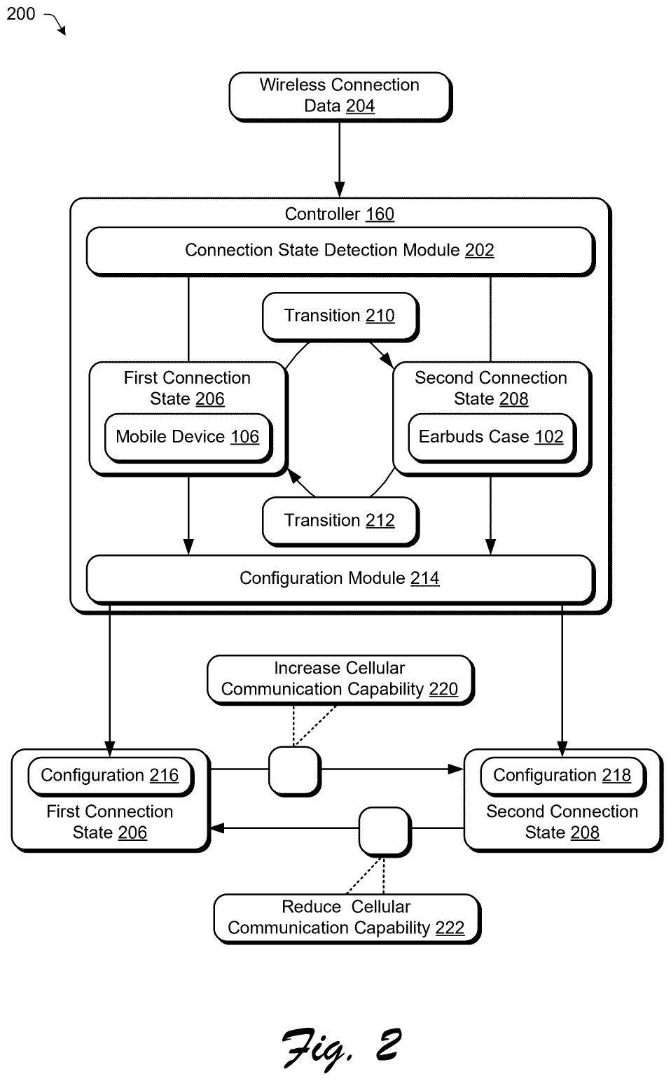

In accordance with the described techniques for cellular capability control of a wireless earbuds case based on wireless connection to an external device, a controller 160 (e.g., implemented in digital circuitry) of the earbuds case 102 is configured to detect a connection state 154 of the wireless earbuds 104, and configure the communication system 116 with the configuration 152 corresponding to the detected connection state 154, as further discussed below with reference to FIG. 2. For example, the connection states 154 include a first connection state in which the wireless earbuds 104 are connected to the mobile device 106, and a second connection state in which the wireless earbuds 104 are connected to the earbuds case 102 and disconnected from the mobile device 106. In one or more implementations, the controller 160 detects a transition from the second connection state to the first connection state. As part of configuring the communication system 116 with the configuration 152 corresponding to the first connection state, the controller 160 reduces the wireless cellular communication capabilities of the communication system 116, thereby reducing thermal activity and improving battery performance.

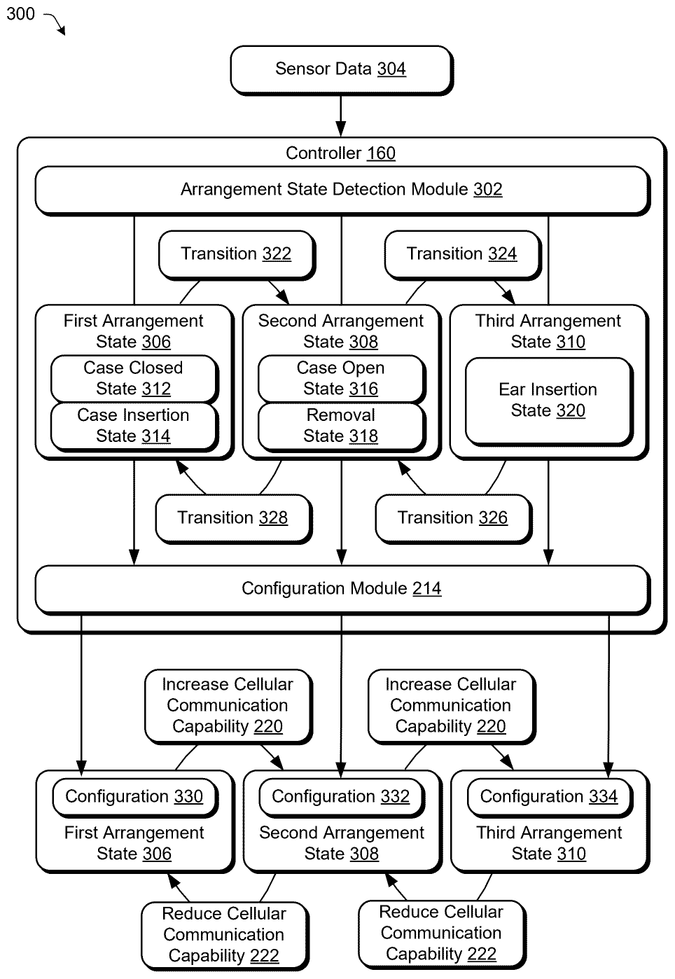

In accordance with the described techniques for cellular capability control of a wireless earbuds case based on a physical arrangement of the wireless earbuds case and wireless earbuds, the controller 160 is configured to detect an arrangement state 158 of the wireless earbuds 104 and the earbuds case 102, and configure the communication system 116 with the configuration 156 corresponding to the detected arrangement state 158, as further discussed below with reference to FIG. 3. For example, the arrangement states 158 include a first arrangement state in which the earbuds case 102 is in the closed position and the wireless earbuds 104 are inserted in the earbuds case 102, a second arrangement state in which the earbuds case 102 is in the open position and the wireless earbuds 104 are removed from the earbuds case 102, and a third arrangement state in which the wireless earbuds 104 are inserted in the ears of a user. In one or more implementations, the controller 160 detects a transition from the third arrangement state to the second arrangement state, or from the second arrangement state to the first arrangement state. As part of configuring the communication system 116 with the configuration 156 of the arrangement state transitioned to, the controller 160 reduces the wireless cellular communication capabilities of the communication system 116, thereby reducing thermal activity and improving battery performance.

Having discussed an example environment in which the disclosed techniques can be performed, consider now some example scenarios and implementation details for implementing the disclosed techniques.

FIG. 2 illustrates an example system 200 for cellular capability control of a wireless earbuds case based on wireless connection to an external device. As shown, the controller 160 includes a connection state detection module 202, which is configured to detect a connection state 154 of the wireless earbuds 104. To do so, the connection state detection module 202 receives wireless connection data 204 indicating whether the wireless earbuds 104 are wirelessly connected to the earbuds case 102 and whether the wireless earbuds 104 are wirelessly connected to the mobile device 106. For instance, the connection state detection module 202 receives wireless connection data 204 from the wireless earbuds 104 or the mobile device 106 indicating whether the wireless earbuds 104 are connected to the mobile device 106 via the peer-to-peer connection 146. Moreover, the connection state detection module 202 receives the wireless connection data 204 from the communication system 116 indicating whether the wireless earbuds 104 are connected to the earbuds case 102 via the peer-to-peer connection 144.

Based on the wireless connection data 204, the connection state detection module 202 detects whether the wireless earbuds 104 are in a first connection state 206 or a second connection state 208, e.g., of the connection states 154. The connection state detection module 202 detects the first connection state 206 when the wireless earbuds 104 are wirelessly connected to the mobile device 106 regardless of whether the wireless earbuds 104 are wirelessly connected to the earbuds case 102. For example, the first connection state 206 includes the wireless earbuds 104 being wirelessly connected to the mobile device 106 and the earbuds case 102, or the wireless earbuds 104 being wirelessly connected to the mobile device 106 and wirelessly disconnected from the earbuds case 102. Furthermore, the connection state detection module 202 detects the second connection state 208 when the wireless earbuds 104 are wirelessly connected to the earbuds case 102 and wirelessly disconnected from the mobile device 106.

As part of detecting the connection state 154 of the wireless earbuds 104, the connection state detection module 202 detects transitions between the first connection state 206 and the second connection state 208. In various scenarios, the connection state detection module 202 detects a transition 210 from the first connection state 206 to the second connection state 208, e.g., responsive to the wireless earbuds 104 being wirelessly disconnected from the mobile device 106 and/or wirelessly connected to the earbuds case 102. In addition, the connection state detection module 202 determines a transition 212 from the second connection state 208 to the first connection state 206, e.g., responsive to the wireless earbuds being connected to the mobile device 106.

As shown, the detected connection state 154 is provided as input to a configuration module 214, which configures the communication system 116 with the configuration 152 associated with the detected connection state 154 in the configuration data 150 of the memory 148. In response to the first connection state 206 being detected, for instance, the configuration module 214 retrieves a configuration 216 paired with the first connection state 206 in the configuration data 150, and configures the communication system 116 with the configuration 216. In response to the second connection state 208 being detected, the configuration module 214 retrieves a configuration 218 paired with the second connection state 208 in the configuration data 150, and configures the communication system 116 with the configuration 218. Notably, the configurations 216, 218 are different. When configured in the configuration 216, for instance, the communication system 116 is configured with reduced cellular communication capabilities relative the configuration 218. Similarly, when configured in the configuration 218, the communication system 116 is configured with increased cellular communication capabilities relative to the configuration 216.

Given this, when the transition 210 is detected from the first connection state 206 to the second connection state 208, the configuration module 214 updates the configuration of the communication system 116 from the configuration 216 to the configuration 218. In doing so, the configuration module 214 performs one or more operations to increase a cellular communication capability of the communication system 116, as illustrated at 220. By configuring the communication system 116 with increased cellular communication capability in the second connection state 208, the described techniques enable and/or improve wireless cellular communication of the earbuds case 102 when wireless cellular communication functionality is solely deliverable by the earbuds case 102, e.g., and not the mobile device 106. In various scenarios, the described techniques thus enable a user to receive important and/or time-sensitive cellular communications via the earbuds case 102 and the wireless earbuds 104 even when the mobile device 106 is not physically present with the user.

Similarly, when the transition 212 is detected from the second connection state 208 to the first connection state 206, the configuration module 214 updates the configuration of the communication system 116 from the configuration 218 to the configuration 216. In doing so, the configuration module 214 performs one or more operations to reduce a cellular communication capability of the communication system 116, as illustrated at 222. By configuring the communication system 116 with reduced cellular communication capability in the first connection state 206, the described techniques reduce thermal activity and improve battery performance for the earbuds case 102 when the cellular communication capabilities of the earbuds case 102 are not needed by a user, e.g., because cellular communication capabilities are deliverable by the mobile device 106. Examples of operations to modulate (e.g., reduce or increase) a cellular communication capability of the communication system 116 are further discussed below with reference to FIG. 4.

FIG. 3 depicts an example system 300 for cellular capability control of a wireless earbuds case based on a physical arrangement of the wireless earbuds case and wireless earbuds. As shown, the controller 160 includes an arrangement state detection module 302, which is configured to detect an arrangement state 158 of the earbuds case 102 and the wireless earbuds 104. To do so, the arrangement state detection module 302 receives sensor data 304 indicating whether the earbuds case 102 is in the closed position or the open position, and whether the wireless earbuds 104 are inserted in the earbuds case 102 or ears of a user. For instance, the arrangement state detection module 302 receives sensor data 304 from the insertion sensors of the wireless earbuds 104 indicating whether the wireless earbuds 104 are inserted in the ears of the user. Furthermore, the arrangement state detection module 302 receives sensor data 304 from the insertion sensor(s) of the earbuds case 102 indicating whether the wireless earbuds 104 are inserted in the earbuds case 102. Moreover, the arrangement state detection module 302 receives sensor data 304 from the positional sensor(s) of the earbuds case 102 indicating whether the earbuds case 102 is in the open position or the closed position.

Based on the sensor data 304, the arrangement state detection module 302 determines whether the earbuds case 102 and the wireless earbuds 104 are in a first arrangement state 306, a second arrangement state 308, or a third arrangement state 310, e.g., of the arrangement states 158. The arrangement state detection module 302 detects the first arrangement state 306 when the earbuds case 102 is in the closed position (e.g., the case closed state 312) and the wireless earbuds 104 are inserted in the earbuds case 102, e.g., the case insertion state 314. Moreover, the arrangement state detection module 302 detects the second arrangement state 308 when the earbuds case 102 is in the open position (e.g., the case open state 316) and the wireless earbuds 104 are removed from the earbuds case 102 but not inserted in the ears of a user, e.g., the removal state 318. Furthermore, the arrangement state detection module 302 detects the third arrangement state 310 when the wireless earbuds 104 are inserted in the ears of a user regardless of whether the earbuds case is in the open position or the closed position, e.g., the ear insertion state 320.

As part of detecting the arrangement state 158 of the earbuds case 102 and the wireless earbuds 104, the arrangement state detection module 302 determines transitions between the first arrangement state 306, the second arrangement state 308, and the third arrangement state 310. By way of example, the arrangement state detection module 302 detects a transition 322 from the first arrangement state 306 to the second arrangement state 308, e.g., responsive to the earbuds case 102 being opened and the wireless earbuds 104 being removed from the earbuds case 102. Further, the arrangement state detection module 302 detects a transition 324 from the second arrangement state 308 to the third arrangement state 310, e.g., responsive to the wireless earbuds 104 being inserted in the ears of the user. In addition, the arrangement state detection module 302 detects a transition 326 from the third arrangement state 310 to the second arrangement state 308, e.g., responsive to the wireless earbuds 104 being removed from the ears of a user and the earbuds case 102 being opened. Moreover, the arrangement state detection module 302 detects a transition 328 from the second arrangement state 308 to the first arrangement state 306, e.g., responsive to the wireless earbuds 104 being inserted in the earbuds case 102 and the earbuds case 102 being closed.

As shown, the detected arrangement state 158 is provided as input to the configuration module 214, which configures the communication system 116 with the configuration 156 associated with the detected arrangement state 158 in the configuration data 150 of the memory 148. In response to the first arrangement state 306 being detected, the configuration module 214 retrieves the configuration 330 paired with the first arrangement state 306 in the configuration data 150, and configures the communication system 116 with the configuration 330. In response to the second arrangement state 308 being detected, the configuration module 214 retrieves the configuration 332 paired with the second arrangement state 308 in the configuration data 150, and configures the communication system 116 with the configuration 332. In response to the third arrangement state 310 being detected, the configuration module 214 retrieves the configuration 334 paired with the third arrangement state 310 in the configuration data 150, and configures the communication system 116 with the configuration 334.

Notably, the configurations 330, 332, 334 are different. For instance, the communication system 116 is configured with an increased level of cellular communication capabilities when configured in the configuration 334 relative to the configurations 332, 334. Moreover, the communication system 116 is configured with an intermediate level of cellular communication capabilities when configured in the configuration 332, e.g., a level of cellular communication capabilities that is greater than the configuration 330 but less than the configuration 334. In addition, the communication system 116 is configured with a reduced level of cellular communication capabilities when configured in the configuration 330 relative to the configurations 332, 334.

Given this, when the transition 322 is detected from the first arrangement state 306 to the second arrangement state 308, the configuration module 214 updates the configuration of the communication system 116 from the configuration 330 to the configuration 332. Similarly, when the transition 324 is detected from the second arrangement state 308 to the third arrangement state 310, the configuration module 214 updates the configuration of the communication system 116 from the configuration 332 to the configuration 334. As part of transitioning the communication system 116 from the configuration 330 to the configuration 332 and from the configuration 332 to the configuration 334, the configuration module 214 performs one or more operations to increase the cellular communication capability of the communication system 116, as illustrated at 220.

Furthermore, when the transition 326 is detected from the third arrangement state 310 to the second arrangement state 308, the configuration module 214 updates the configuration of the communication system 116 from the configuration 334 to the configuration 332. Similarly, when the transition 328 is detected from the second arrangement state 308 to the first arrangement state 306, the configuration module 214 updates the configuration of the communication system 116 from the configuration 332 to the configuration 330. As part of transitioning the communication system 116 from the configuration 334 to the configuration 332 and from the configuration 332 to the configuration 330, the configuration module 214 performs one or more operations to reduce the cellular communication capability of the communication system 116, as illustrated at 222.

Notably, the different arrangement states 308 are indicative of different degrees of usage of the wireless earbuds 104. For example, the first arrangement state 306 indicates that the user is not using the wireless earbuds 104, the second arrangement state 308 indicates that the user is transitioning to using the wireless earbuds 104, and the third arrangement state 310 indicates that the user is actively using the wireless earbuds 104. By modulating cellular communication capability of the communication system 116 based on the arrangement states 306, 308, 310 in the manner described, therefore, the described techniques enable and/or improve wireless cellular communications when usage of the the wireless earbuds 104 increases and the wireless cellular communication capabilities are being utilized by a user. In addition, the described techniques reduce thermal activity and improve battery performance for the earbuds case 102 when usage of the wireless earbuds 104 decreases and the user's utilization of and/or need for wireless cellular communication capabilities is eliminated and/or diminished.

FIG. 4 depicts an example 400 showing manners in which a controller of a wireless earbuds case modulates wireless cellular communication capabilities of the wireless earbuds case. At 220, the example 400 includes example operations performable by the controller 160 when updating a configuration of the communication system 116 to increase a wireless cellular communication capability of the communication system 116. At 222, the example 400 includes example operations performable by the controller 160 when updating a configuration of the communication system 116 to reduce a wireless cellular communication capability of the communication system 116.

In one or more implementations, the controller 160 updates a configuration of the communication system 116 to modulate the cellular communication capability of the communication system 116 by updating a power state of the modem 124. Different power states of the modem 124 include an active power state, an idle power state, a partially powered off state, a periodic power state, and a powered off state. In the active power state, the modem 124 is powered on, connected to the cellular network, and actively transmitting and receiving data. In the idle power state, the modem 124 is powered on, connected to the cellular network, but not actively transmitting and receiving data. In the partially powered off state, one or more circuitry components of the modem 124 are powered off and/or in a low-power or standby state. By way of example, RF transceivers (used for sending and receiving RF signals), processing circuitry, and communication interface of the modem 124 may be powered off, while monitoring circuits remain active and powered on. Here, the monitoring circuits are configured to detect a trigger event (e.g., receiving a cellular communication), which triggers the modem 124 being transitioned back to the active power state. In the periodic power state, the modem 124 is completely powered off, but periodically powered on for a predefined duration to enable receival of cellular data. For example, the modem 124 is powered on every five minutes to check whether any cellular communications have been received during the preceding time interval, and if so, communicate the cellular communication for output by the speakers 136 of the wireless earbuds 104. In the powered off state (e.g., airplane mode), the modem 124 is completely powered off.

At 402, the controller 160 increases a wireless cellular capability of the communication system 116 by increasing the power state of the modem 124 from a reduced power state (e.g., the idle power state, the partially powered off state, the periodic power state, or the powered off state) to the active power state. At 404, the controller 160 reduces a wireless cellular capability of the communication system 116 by reducing the power state of the modem 124 from the active power state to the reduced power state. In one example, the configuration 216 of the first connection state 206 includes the reduced power state (e.g., the idle power state, the partially powered off state, the periodic power state, or the powered off state) and the configuration 218 of the second connection state 206 includes the active power state. In another example, the configuration 330 of the first arrangement state 306 includes the powered off state, the partially powered off state or the periodic power state, the configuration 332 of the second arrangement state 308 includes the idle state, and the configuration 334 of the third arrangement state 310 includes the active power state.

Additionally or alternatively, the controller 160 updates a configuration of the communication system 116 to modulate the cellular communication capability of the communication system 116 by instructing the antenna switching network 130 to activate or deactivate cellular antennas of the antenna system 120. As previously mentioned, the antenna system 120 includes one cellular antenna in the base 108 and one cellular antenna in the lid 110. At 406, the controller 160 increases the increases a wireless cellular capability of the communication system 116 by instructing the antenna system to activate at least one antenna of the cellular antennas. At 408, the controller 160 reduces the cellular communication capability of the communication system 116 by instructing the antenna switching network 130 to deactivate at least one of the cellular antennas. In one example, the configuration 216 of the first connection state 206 includes one of the following active/inactive antenna combinations: (1) the lid antenna deactivated and the base antenna activated or (2) both the base antenna and the lid antenna deactivated. Furthermore, the configuration 218 of the second connection state 208 includes both the base antenna and the lid antenna activated and aggregated. In another example, the configuration 330 of the first arrangement state 306 includes both the base antenna and the lid antenna deactivated, the configuration 332 of the second arrangement state 308 includes the includes the base antenna activated and the lid antenna deactivated, and the configuration 334 includes both the base antenna and the lid antenna activated and aggregated.

In various implementations, the controller 160 updates the configuration of the communication system 116 to modulate the cellular communication capability of the communication system 116 by updating a transmit power at which one or more circuitry components (e.g., the modem 124 and/or the RF front end 122) of the communication system 116 operate to transmit cellular data. Broadly, a transmit power class of a device (e.g., the modem 124 or RF front end 122) defines a maximum power output for the device when transmitting signals. At 410, the controller 160 increases the wireless cellular capability of the communication system 116 by increasing a transmit power class of the modem 124 and/or the RF front end 122 to enable a greater transmission power. At 412, the controller 160 reduces the wireless cellular capability of the communication system 116 by reducing a transmit power class of the modem 124 and/or the RF front end 122 to reduce the transmission power.

Additionally or alternatively, the controller 160 updates the configuration of the communication system 116 to modulate the cellular communication capability of the communication system 116 by updating an RF bandwidth at which the communication system 116 receives and transmits cellular data. Broadly, RF bandwidth refers to a range of RF signal frequencies at which the communication system 116 receives and transmits cellular data. Given this, reducing the RF bandwidth of the communication system 116 includes reducing the range of frequencies at which the communication system 116 transmits and receives cellular data, while increasing the RF bandwidth of the communication system 116 includes increasing the range of frequencies at which the communication system 116 transmits and receives cellular data At 414, the controller 160 increases the wireless cellular capability of the communication system 116 by increasing the RF bandwidth at which the communication system 116 transmits and receives cellular data. At 416, the controller 160 reduces the wireless cellular capability of the communication system 116 by reducing the RF bandwidth at which the communication system 116 transmits and receives cellular data.

In various implementations, the controller 160 updates the configuration of the communication system 116 to modulate the cellular communication capability of the communication system 116 by modifying a radio access technology (RAT) by which the communication system receives and transmits cellular data. An RAT is the underlying technology used by cellular communication systems to connect devices to a cellular network. Different RATs include, by way of example and not limitation, 3G, 4G LTE, and 5G. Moreover, one or more RATs include different versions providing different capabilities within a particular RAT. For example, the 5G RAT includes 5G FR1 (e.g., sub-6 GHz) and 5G FR2 (mmWave), and 5G FR2 provides increased speed (e.g., data rate) as compared to 5G FR1.

At 418, the controller 160 increases the wireless cellular capability of the communication system 116 by upgrading the RAT by which the communication system 116 transmits and receives cellular data. Here, upgrading the RAT includes changing the RAT of the communication system 116 from an RAT generally associated with reduced communication performance to an RAT generally associated with increased communication performance, e.g., changing from 3G to 4G LTE, or 4G LTE to 5G. Additionally or alternatively, upgrading the RAT includes changing a version of a particular RAT from a version of the particular RAT generally associated with reduced communication performance (e.g., reduced data rate) to a version of the particular RAT generally associated with increased communication performance, e.g., increased data rate. One example of upgrading the RAT, for instance, includes modifying the RAT of the communication system 116 from 5G FR1 to 5G FR2.

At 420, the controller 160 reduces the wireless cellular capability of the communication system 116 by reducing the RAT by which the communication system 116 transmits and receives cellular data. Here, reducing the RAT includes changing the RAT of the communication system 116 from an RAT generally associated with increased communication performance to an RAT generally associated with reduced communication performance, e.g., changing from 5G to 4G LTE, or from 4G LTE to 3G. Additionally or alternatively, reducing the RAT includes changing a version of a particular RAT from a version of the particular RAT generally associated with increased communication performance (e.g., increased data rate) to a version of the particular RAT generally associated with reduced communication performance, e.g., reduced data rate. One example of reducing the RAT, for instance, includes modifying the RAT of the communication system 116 from 5G FR2 to 5G FR1.

Additionally or alternatively, the controller 160 updates the configuration of the communication system 116 to modulate the cellular communication capability of the communication system by updating a carrier aggregation of the communication system, e.g., adding or removing component carriers at which the communication system 116 receives and transmits cellular data. By way of example an RF band refers to a range of frequencies designated for a specific type of wireless communication, e.g., 4G LTE. Furthermore, a component carrier is a specific range of frequencies within an RF band, e.g., occupying twenty MHz of an eight-hundred MHz band. At 422, the controller 160 increases the wireless cellular capability of the communication system 116 by adding one or more component carriers at which the communication system 116 receives and transmits cellular data. At 424, the controller 160 reduces the wireless cellular capability of the communication system 116 by removing one or more component carriers at which the communication system 116 transmits and receives cellular data.

In one or more implementations, the controller 160 updates the configuration of the communication system 116 to modulate the cellular communication capability of the communication system 116 by updating a Radio Resource Control (RRC) connection state of the communication system 116 with the cellular network. Broadly, the RRC connection state refers to the current status of the earbuds case 102 and the communication system 116 with the cellular network. Examples of RRC connection state include idle, connected, and inactive. In the RRC idle state, the communication system 116 is not actively communicating with the cellular network, but it is still registered and monitored by the network. In the RRC connected state, the communication system 116 has an active connection with the cellular network, and the cellular network allocates resources to the communication system 116 for data transfer. The RRC inactive state is an intermediate state that consumes less power than the RRC connected state and enables the communication system to quickly resume cellular communication activity without the overhead of re-establishing a full cellular connection. At 426, the controller 160 increases the wireless cellular capability of the communication system 116 by increasing the RRC connection state, e.g., from RRC idle to RRC connected, RRC idle to RRC inactive, or RRC inactive to RRC connected. At 428, the controller 160 reduces the wireless cellular communication capability of the communication system 116 by reducing the RRC connection state, e.g., from RRC connected to RRC idle, from RRC connected to RRC inactive, or from RRC inactive to RRC idle.

It should be noted that any combination of one or more of the aforementioned operations to increase wireless cellular communication capability (e.g., shown at 220) are performable by the controller 160 responsive to detecting the transitions 210, 322, 324. Moreover, different ones of the transitions 210, 322, 324 trigger different combinations of the aforementioned operations to increase the cellular communication capability of the communication system 116 in one or more implementations. Similarly, any combination of one or more of the aforementioned operations to reduce wireless cellular communication capability (e.g., shown at 222) are performable by the controller 160 responsive to detecting the transitions 212, 326, 328. Furthermore, different ones of the transitions 210, 322, 324 trigger different combinations of the aforementioned operations to reduce the cellular communication capability of the communication system 116 in various implementations. Moreover, each of the operations to reduce the wireless cellular communication capability (e.g., as shown at 222) are effective to reduce power consumed by the communication system 116, and as such, reduce the thermal activity and improve batter performance of the earbuds case 102.

Moreover, while the described techniques are described herein as implemented to reduce a cellular communication capability of the communication system 116 with a cellular network, it is to be appreciated that similar operations are performable by the controller 160 to reduce a wireless communication capability of the communication system 116 with a Wi-Fi network. For example, the controller 160 updates the configuration of the communication system 116 to increase the wireless communication capabilities of the communication system 116 with a Wi-Fi network responsive to detecting the transitions 210, 322, 324. Examples of configuration updates to increase wireless communication capabilities of the communication system 116 with a Wi-Fi network include increasing a power state of the modem 124, activating one or more Wi-Fi antennas of the antenna system 120, increasing an RF bandwidth at which the communication system 116 receives and transmits Wi-Fi signals, and adding component carriers at which the communication system 116 receives and transmits Wi-Fi signals. Similarly, the controller 160 updates the configuration of the communication system 116 to reduce the wireless communication capabilities of the communication system 116 with a Wi-Fi network responsive to detecting the transitions 212, 326, 328. Examples of configuration updates to reduce wireless communication capabilities of the communication system 116 with a Wi-Fi network include reducing a power state of the modem 124, deactivating one or more Wi-Fi antennas of the antenna system 120, increasing an RF bandwidth at which the communication system 116 receives and transmits Wi-Fi signals, and adding component carriers at which the communication system 116 receives and transmits Wi-Fi signals.

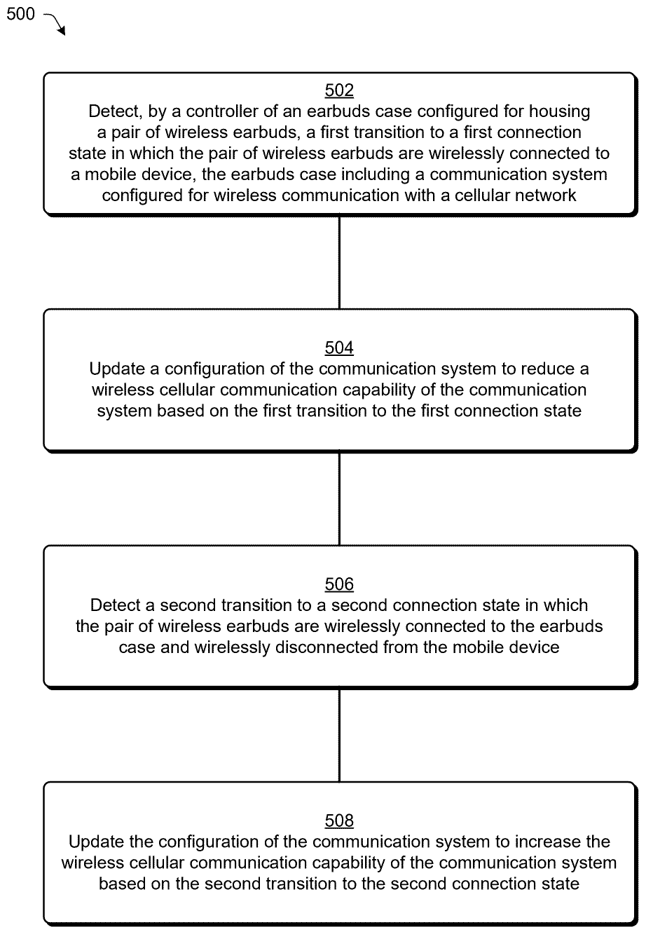

FIG. 5 illustrates a flow chart depicting an example method 500 of cellular capability control of a wireless earbuds case based on wireless connection to an external device. At 502, a controller of an earbuds case configured for housing a pair of wireless earbuds detects a first transition to a first connection state in which the pair of wireless earbuds are wirelessly connected to a mobile device, and the earbuds case includes a communication system configured for wireless communication with a cellular network. For example, the controller 160 of the earbuds case 102 detects the transition 212 from the second connection state 208 (in which the wireless earbuds are wirelessly connected to the earbuds case 102 and disconnected from the mobile device 106) to the first connection state 206 (in which the wireless earbuds 104 are wirelessly connected to the mobile device 106). As discussed, the earbuds case 102 includes the communication system 116 configured for wireless communication with a cellular network of the networks 118.

At 504, a configuration of the communication system is updated to reduce a wireless communication capability of the communication system based on the first transition to the first connection state. Responsive to detecting the transition 212, for instance, the controller 160 updates the configuration of the communication system 116 from the configuration 218 (paired with the second connection state 208 in the configuration data 150) to the configuration 216 (paired with the first connection state 206 in the configuration data 150). In doing so, the controller 160 reduces a cellular communication capability of the communication system 116.

At 506, a second transition is detected to a second connection state in which the pair of wireless earbuds are wirelessly connected to the earbuds case and wirelessly disconnected from the mobile device. For example, the controller 160 detects the transition 210 from the first connection state 206 (in which the wireless earbuds 104 are wirelessly connected to the mobile device 106) to the second connection state 208 (in which the wireless earbuds are wirelessly connected to the earbuds case 102 and disconnected from the mobile device 106).

At 508, the configuration of the communication system is updated to increase the wireless cellular communication capability of the communication system based on the second transition to the second connection state. Responsive to detecting the transition 210, for instance, the controller 160 updates the configuration of the communication system 116 from the configuration 216 (paired with the first connection state 206 in the configuration data 150) to the configuration 218 (paired with the second connection state 208 in the configuration data 150). In doing so, the controller 160 increases a cellular communication capability of the communication system 116.

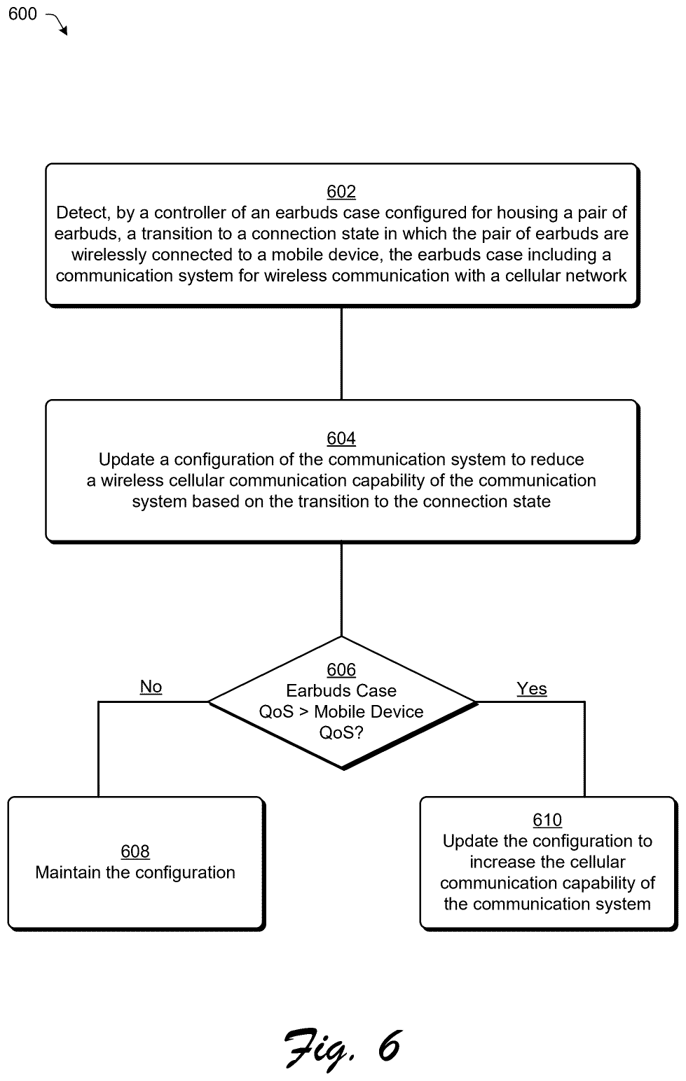

FIG. 6 illustrates a flow chart depicting an example method 600 of cellular capability control of a wireless earbuds case based on wireless connection to an external device to restore a wireless cellular capability of the earbuds case based on quality of service deliverable by the earbuds case and the external device. At 602, a controller of an earbuds case configured for housing a pair of wireless earbuds detects a transition to a connection state in which the pair of wireless earbuds are wirelessly connected to a mobile device, and the earbuds case includes a communication system configured for wireless communication with a cellular network. For example, the controller 160 of the earbuds case 102 detects the transition 212 from the second connection state 208 (in which the wireless earbuds are wirelessly connected to the earbuds case 102 and disconnected from the mobile device 106) to the first connection state 206 (in which the wireless earbuds 104 are wirelessly connected to the mobile device 106). As discussed, the earbuds case 102 includes the communication system 116 configured for wireless communication with a cellular network of the networks 118.

At 604, a configuration of the communication system is updated to reduce a wireless communication capability of the communication system based on the first transition to the first connection state. Responsive to detecting the transition 212, for instance, the controller 160 updates the configuration of the communication system 116 from the configuration 218 (paired with the second connection state 208 in the configuration data 150) to the configuration 216 (paired with the first connection state 206 in the configuration data 150). In doing so, the controller 160 reduces a cellular communication capability of the communication system 116. In a specific but non-limiting example, the controller 160 reduces the cellular communication capability of the communication system 116 by transitioning the modem 124 from the active power state to the powered off state.

At 606, it is determined whether the earbuds case or the mobile device is capable of delivering a higher quality of service (QoS). By way of example, the controller 160 receives QoS data from the mobile device 106 and from the communication system 116. The QoS data includes and/or indicates various QoS metrics, including but not limited to, signal strength, data rate and throughput (e.g., current download/upload speeds), latency (e.g., an amount of time for a data packet to travel to the cellular network and back to the communication system 116), jitter (e.g., variability in latency), RAT being used (e.g., 3G, 4G LTE, or 5G), carrier aggregation and RF bandwidth, and network load and congestion of the cellular network communicated with by the device (e.g., the earbuds case 102 or the mobile device 106). Factors leading to increased QoS include increased signal strength, increased data rate and throughput, reduced latency and jitter, implementation of generally better performing RATs (e.g., 5G rather than 3G or 4G LTE), increased component carrier aggregation and RF bandwidth, and reduced network load and congestion. Similarly, factors leading to decreased QoS include reduced signal strength, reduced data rate and throughput, increased latency and jitter, implementation of generally worse performing RATs (e.g., 3G rather than 5G or 4G LTE), reduced component carrier aggregation and RF bandwidth, increased network load and congestion. Moreover, different combinations of QoS metrics and/or different QoS metrics are weighted differently for computing QoS for different applications, e.g., voice call applications, SMS message communication applications, video streaming applications, web browsing applications and so on.

Before updating the configuration of the communication system 116 to reduce the wireless cellular communication capability (e.g., at 604), the controller 160 collects QoS data from the communication system 116. In addition, the controller 160 receives the QoS data of the mobile device 106 via a Bluetooth connection, UWB connection, or other peer-to-peer connection enabling short-range communication of data. Based on the QoS data, the controller 160 determines whether the QoS deliverable by the earbuds case 102 is greater than the QoS deliverable by the mobile device 106.

If the QoS deliverable by the earbuds case 102 is not greater than the QoS deliverable by the mobile device 106 (e.g., “No” at 606), the controller 160 maintains the configuration 216 of the communication system 116 to maintain the cellular communication capability of the communication system 116 (e.g., block 608). For example, the modem 124 remains in the powered off state. If the QoS deliverable by the earbuds case 102 is greater than the QoS deliverable by the mobile device 106 (e.g., “Yes” at 606), the controller 160 updates the configuration of the communication system 116 to increase the cellular communication capability of the communication system 116 (e.g., block 610). By way of example, the controller 160 restores the configuration 218 to increase the cellular communication capability of the communication system 116, e.g., by transitioning the modem 124 to the active state.

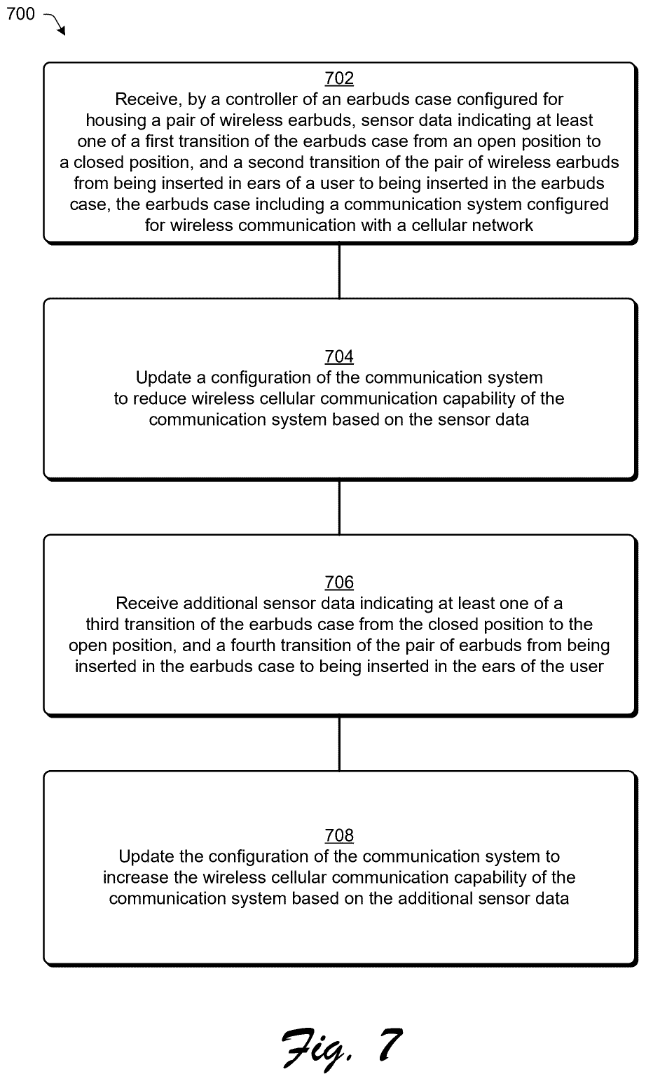

FIG. 7 illustrates a flow chart depicting an example method 700 of cellular capability control of a wireless earbuds case based on a physical arrangement of the wireless earbuds case and wireless earbuds. At 702, a controller of an earbuds case configured for housing a pair of wireless earbuds receives sensor data indicating at least one of a first transition of the earbuds case from an open position to a closed position and a second transition of the pair of wireless earbuds from being inserted in ears of a user to being inserted in the earbuds case, and the earbuds case includes a communication system configured for wireless communication with a cellular network. For example, the controller 160 of the earbuds case 102 receives sensor data 304 indicating whether the earbuds case 102 is in the open position or the closed position, and whether the wireless earbuds 104 are inserted in the earbuds case 102 or ears of the user. Based on the sensor data 304, the controller 160 detects the transition 326 from the third arrangement state 310 (e.g., in which the wireless earbuds 104 are inserted in the ears of the user) to the second arrangement state 308 (e.g., in which the earbuds case is in the open position and the wireless earbuds are removed from the earbuds case 102). Additionally or alternatively, the controller 160 detects the transition 328 from the second arrangement state 308 to the first arrangement state 306, e.g., in which the wireless earbuds 104 are inserted in the earbuds case 102 and the earbuds case 102 is in the closed position. As discussed, the earbuds case 102 includes the communication system 116 configured for wireless communication with a cellular network of the networks 118.

At 704, a configuration of the communication system is updated to reduce wireless cellular communication capability of the communication system based on the sensor data. Responsive to detecting the transition 326, for instance, the controller 160 updates the configuration of the communication system 116 from the configuration 334 (paired with the third arrangement state 310 in the configuration data 150) to the configuration 332 (paired with the second arrangement state 308 in the configuration data 150). Further, responsive to detecting the transition 328, the controller 160 updates the configuration from the configuration 332 (paired with the second arrangement state 308 in the configuration data 150) to the configuration 330 (paired with the first arrangement state 306 in the configuration data 150). In updating the configuration from the configuration 334 to the configuration 332 or from the configuration 332 to the configuration 330, the controller 160 reduces a cellular communication capability of the communication system 116.

At 706, additional sensor data is received indicating at least one of a third transition of the earbuds case from the closed position to the open position, and a fourth transition of the pair of earbuds from being inserted in the earbuds case to being inserted in the ears of the user. By way of example, the controller 160 of the earbuds case 102 receives sensor data 304 indicating whether the earbuds case 102 is in the open position or the closed position, and whether the wireless earbuds 104 are inserted in the earbuds case 102 or ears of the user. Based on the sensor data 304, the controller 160 detects the transition 322 from the first arrangement state (e.g., in which the wireless earbuds 104 are inserted in the earbuds case 102 and the earbuds case 102 is in the closed position) to the second arrangement state 308, e.g., in which the earbuds case 102 is in the open position and the wireless earbuds are removed from the earbuds case 102. Additionally or alternatively, the controller 160 detects the transition 324 from the second arrangement state 308 to the third arrangement state 310, e.g., in which the wireless earbuds 104 are inserted in the ears of the user.

At 708, the configuration of the communication system is updated to increase the wireless cellular communication capability of the communication system based on the additional sensor data. Responsive to detecting the transition 322, for instance, the controller 160 updates the configuration of the communication system 116 from the configuration 330 (paired with the first arrangement state 306 in the configuration data 150) to the configuration 332 (paired with the second arrangement state 308 in the configuration data 150). Responsive to detecting the transition 324, the controller 160 updates the configuration of the communication system 116 from the configuration 332 (paired with the second arrangement state 308 in the configuration data) to the configuration 334 (paired with the third arrangement state 310 in the configuration data). In updating the configuration from the configuration 330 to the configuration 332 or from the configuration 332 to the configuration 334, the controller 160 increases a cellular communication capability of the communication system 116.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

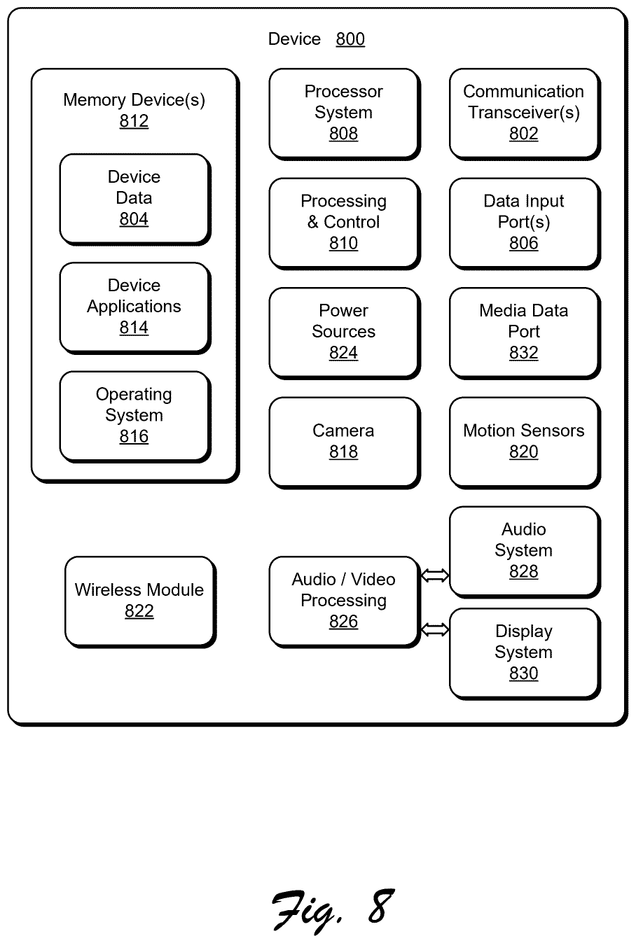

FIG. 8 illustrates various components of an example device 800 in which aspects of the described techniques can be implemented. For example, the mobile device 106 as shown and described with reference to FIGS. 1-7 may be implemented as the example device 800.

The device 800 includes communication transceivers 802 that enable wired and/or wireless communication of device data 804 with other devices. The device data 804 can include any of device identifying data, device location data, wireless connectivity data, and wireless protocol data. Additionally, the device data 804 can include any type of audio, video, and/or image data. Example communication transceivers 802 include wireless personal area network (WPAN) radios compliant with various IEEE 802.15 (Bluetooth™) standards, wireless local area network (WLAN) radios compliant with any of the various IEEE 802.10 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 800 may also include one or more data input ports 806 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 800 includes a processing system 808 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 810. The device 800 may further include any type of a system bus or other data and command transfer system that couples the various components within the device. A system bus can include any one or combination of different bus structures and architectures, as well as control and data lines.

The device 800 also includes computer-readable storage memory 812 (e.g., memory devices) that enable data storage, such as data storage devices that can be accessed by a computing device, and that provide persistent storage of data and executable instructions (e.g., software applications, programs, functions, and the like). Examples of the computer-readable storage memory 812 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 800 may also include a mass storage media device.

The computer-readable storage memory 812 provides data storage mechanisms to store the device data 804, other types of information and/or data, and various device applications 814 (e.g., software applications). For example, an operating system 816 can be maintained as software instructions with a memory device and executed by the processing system 808. The device applications may include a device manager, such as any form of a control application, software application, signal-processing and control module, code that is native to a particular device, a hardware abstraction layer for a particular device, and so on. Computer-readable storage memory 812 represents media and/or devices that enable persistent and/or non-transitory storage of information in contrast to mere signal transmission, carrier waves, or signals per se. Computer-readable storage memory 812 do not include signals per se or transitory signals.

The example device 800 can also include a camera 818 and motion sensors 820. The motion sensors 820, for instance, may include motion sensors such as may be implemented in an inertial measurement unit (IMU). The motion sensors 820 can be implemented with various sensors, such as a gyroscope, an accelerometer, and/or other types of motion sensors to sense motion of the device.

The device 800 also includes a wireless module 822, which is representative of functionality to perform various wireless communication tasks. The device 800 can also include one or more power sources 824, such as when the device is implemented as a mobile device. The power sources 824 may include a charging and/or power system, and can be implemented as a flexible strip battery, a rechargeable battery, a charged super-capacitor, and/or any other type of active or passive power source.

The device 800 also includes an audio and/or video processing system 826 that generates audio data for an audio system 828 and/or generates display data for a display system 830. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 832. In implementations, the audio system and/or the display system are integrated components of the example device. Alternatively, the audio system and/or the display system are external, peripheral components to the example device.

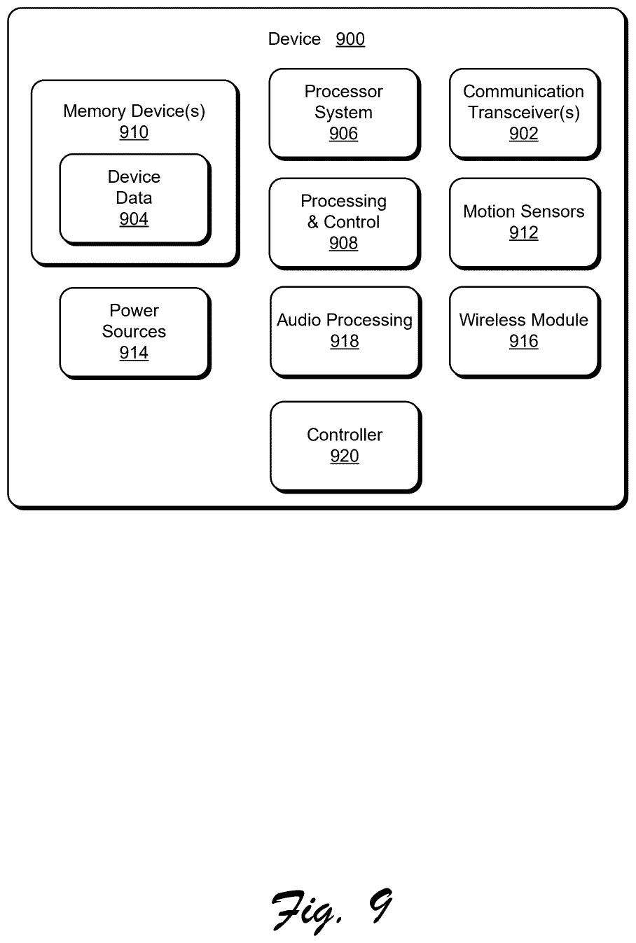

FIG. 9 illustrates various components of an example device in which aspects of the described techniques can be implemented. For example, the earbuds case 102 as shown and described with reference to FIGS. 1-7 may be implemented as the example device 900. Here, the communication transceivers 902, the device data 904, the processor system 906, the processing & control circuits 908, the memory 910 device(s), the motion sensors 912, the power sources 914, and the wireless module 916 correspond to and/or are implemented similarly to the communication transceivers 802, the device data 804, the processor system 808, the processing & control circuits 810, the memory 812 device(s), the motion sensors 820, the power sources 824, and the wireless module 822, respectively, as depicted and described with reference to the example device 800 of FIG. 8. Additionally, the example device 900 includes an audio processing system 918 which generates audio data for an external audio system, e.g., the speakers 136 of the wireless earbuds 104.

In this example, the device 900 includes a controller 920 that implements aspects of cellular capability control of a wireless earbuds case based on wireless connection to an external device. For example, the controller 920 can be implemented as the controller 160 described in detail above. In implementations, the controller 920 may include independent processing, memory, and logic components as a computing and/or electronic device integrated with the device 900.

Although implementations of cellular capability control of a wireless earbuds case based on wireless connection to an external device have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In some aspects, the techniques described herein relate to a device configured as an earbuds case for housing a pair of wireless earbuds, the device comprising a communication system configured for wireless communication with a cellular network, and a controller to detect a connection state of the wireless earbuds indicating whether the wireless earbuds are wirelessly connected to a mobile device and whether the wireless earbuds are wirelessly connected to the earbuds case, and update a configuration of the communication system to modulate a wireless cellular communication capability of the communication system based on the connection state.

In some aspects, the techniques described herein relate to a device, wherein to detect the connection state, the controller is configured to detect a transition to the connection state in which the pair of wireless earbuds are wirelessly connected to the mobile device, and to update the configuration, the controller is configured to reduce the wireless cellular communication capability based on the transition to the connection state.

In some aspects, the techniques described herein relate to a device, wherein to detect the connection state, the controller is configured to detect a transition to the connection state in which the pair of wireless earbuds are wirelessly connected to the earbuds case and wirelessly disconnected from the mobile device, and to update the configuration, the controller is configured to increase the wireless cellular communication capability based on the transition to the connection state.

In some aspects, the techniques described herein relate to a device, wherein to update the configuration, the controller is configured to update a power state of a modem of the communication system.

In some aspects, the techniques described herein relate to a device, wherein the communication system includes multiple radio frequency antennas communicatively coupled to an antenna switching network, and to update the configuration, the controller is configured to instruct the antenna switching network to activate or deactivate at least one of the multiple radio frequency antennas.

In some aspects, the techniques described herein relate to a device, wherein to update the configuration, the controller is configured to update a transmit power class at which the communication system operates to transmit cellular data.

In some aspects, the techniques described herein relate to a device, wherein to update the configuration, the controller is configured to update a radio frequency bandwidth at which the communication system receives and transmits cellular data.

In some aspects, the techniques described herein relate to a device, wherein to update the configuration, the controller is configured to modify a radio access technology by which the communication system receives and transmits cellular data.

In some aspects, the techniques described herein relate to a device, wherein to update the configuration, the controller is configured to update a carrier aggregation of the communication system by adding or removing component carriers at which the communication system receives and transmits cellular data.

In some aspects, the techniques described herein relate to a device, wherein to update the configuration, the controller is configured to update a Radio Resource Control (RRC) connection state of the communication system with the cellular network.

In some aspects, the techniques described herein relate to a device configured as an earbuds case for housing a pair of wireless earbuds, the device comprising a communication system configured for wireless communication with a cellular network, and a controller to detect a transition to a connection state in which the pair of wireless earbuds are wirelessly connected to a mobile device, and update a configuration of the communication system to reduce a wireless cellular communication capability of the communication system based on the transition to the connection state.

In some aspects, the techniques described herein relate to a device, wherein to update the configuration, the controller is configured to transition a modem of the communication system from an active power state in which the modem is powered on and actively transmitting and receiving data to an idle power state in which the modem is powered on but not actively transmitting and receiving data.

In some aspects, the techniques described herein relate to a device, wherein to update the configuration, the controller is configured to transition a modem of the communication system from an active power state in which the modem is powered on to a partially powered off state in which one or more circuitry components of the modem are powered off.

In some aspects, the techniques described herein relate to a device, wherein to update the configuration, the controller is configured to transition a modem of the communication system from an active power state in which the modem is powered on to a powered off state in which the modem is powered off.

In some aspects, the techniques described herein relate to a device, wherein to update the configuration, the controller is configured to transition a modem of the communication system from an active power state in which the modem is powered on to a periodic power state in which the modem is powered off but periodically powered on for a predefined duration to enable receival of cellular data.

In some aspects, the techniques described herein relate to a device, wherein the controller is further configured to detect an additional transition from the connection state to an additional connection state in which the pair of earbuds are wirelessly connected to the earbuds case and wirelessly disconnected from the mobile device, and update the configuration of the communication system to increase the wireless cellular communication capability of the communication system based on the additional transition to the additional connection state.

In some aspects, the techniques described herein relate to a device, wherein the controller is further configured to receive an indication of a first quality of service delivered by the mobile device, determine a second quality of service deliverable by the earbuds case, and update the configuration of the communication system to increase the wireless cellular communication capability of the communication system based on the second quality of service exceeding the first quality of service.

In some aspects, the techniques described herein relate to a method comprising detecting, by a controller of an earbuds case configured for housing a pair of wireless earbuds, a transition to a connection state in which the pair of wireless earbuds are wirelessly connected to the earbuds case and wirelessly disconnected from a mobile device, the earbuds case including a communication system configured for wireless communication with a wireless network, and updating a configuration of the communication system to increase a wireless communication capability of the communication system based on the transition to the connection state.

In some aspects, the techniques described herein relate to a method, wherein the wireless network is a Wi-Fi network or a cellular network.

In some aspects, the techniques described herein relate to a method, further comprising detecting an additional transition from the connection state to an additional connection state in which the pair of wireless earbuds are wirelessly connected to the mobile device, and updating the configuration of the communication system to reduce the wireless communication capability of the communication system based on the additional transition to the additional connection state.

What is claimed is:

1. A device configured as an earbuds case for housing a pair of wireless earbuds, the device comprising:
a communication system configured for wireless communication with a cellular network; and
a controller to:
detect a connection state of the wireless earbuds indicating whether the wireless earbuds are wirelessly connected to a mobile device and whether the wireless earbuds are wirelessly connected to the earbuds case; and
update a configuration of the communication system to modulate a wireless cellular communication capability of the communication system based on the connection state.

2. The device of claim 1, wherein to detect the connection state, the controller is configured to detect a transition to the connection state in which the pair of wireless earbuds are wirelessly connected to the mobile device, and to update the configuration, the controller is configured to reduce the wireless cellular communication capability based on the transition to the connection state.

3. The device of claim 1, wherein to detect the connection state, the controller is configured to detect a transition to the connection state in which the pair of wireless earbuds are wirelessly connected to the earbuds case and wirelessly disconnected from the mobile device, and to update the configuration, the controller is configured to increase the wireless cellular communication capability based on the transition to the connection state.

4. The device of claim 1, wherein to update the configuration, the controller is configured to update a power state of a modem of the communication system.

5. The device of claim 1, wherein the communication system includes multiple radio frequency antennas communicatively coupled to an antenna switching network, and to update the configuration, the controller is configured to instruct the antenna switching network to activate or deactivate at least one of the multiple radio frequency antennas.

6. The device of claim 1, wherein to update the configuration, the controller is configured to update a transmit power class at which the communication system operates to transmit cellular data.

7. The device of claim 1, wherein to update the configuration, the controller is configured to update a radio frequency bandwidth at which the communication system receives and transmits cellular data.

8. The device of claim 1, wherein to update the configuration, the controller is configured to modify a radio access technology by which the communication system receives and transmits cellular data.

9. The device of claim 1, wherein to update the configuration, the controller is configured to update a carrier aggregation of the communication system by adding or removing component carriers at which the communication system receives and transmits cellular data.

10. The device of claim 1, wherein to update the configuration, the controller is configured to update a Radio Resource Control (RRC) connection state of the communication system with the cellular network.

11. A device configured as an earbuds case for housing a pair of wireless earbuds, the device comprising:
a communication system configured for wireless communication with a cellular network; and
a controller to:
detect a transition to a connection state in which the pair of wireless earbuds are wirelessly connected to a mobile device; and
update a configuration of the communication system to reduce a wireless cellular communication capability of the communication system based on the transition to the connection state.

12. The device of claim 11, wherein to update the configuration, the controller is configured to transition a modem of the communication system from an active power state in which the modem is powered on and actively transmitting and receiving data to an idle power state in which the modem is powered on but not actively transmitting and receiving data.

13. The device of claim 11, wherein to update the configuration, the controller is configured to transition a modem of the communication system from an active power state in which the modem is powered on to a partially powered off state in which one or more circuitry components of the modem are powered off.

14. The device of claim 11, wherein to update the configuration, the controller is configured to transition a modem of the communication system from an active power state in which the modem is powered on to a powered off state in which the modem is powered off.

15. The device of claim 11, wherein to update the configuration, the controller is configured to transition a modem of the communication system from an active power state in which the modem is powered on to a periodic power state in which the modem is powered off but periodically powered on for a predefined duration to enable receival of cellular data.

16. The device of claim 11, wherein the controller is further configured to:
detect an additional transition from the connection state to an additional connection state in which the pair of earbuds are wirelessly connected to the earbuds case and wirelessly disconnected from the mobile device; and
update the configuration of the communication system to increase the wireless cellular communication capability of the communication system based on the additional transition to the additional connection state.

17. The device of claim 11, wherein the controller is further configured to:
receive an indication of a first quality of service delivered by the mobile device;
determine a second quality of service deliverable by the earbuds case; and
update the configuration of the communication system to increase the wireless cellular communication capability of the communication system based on the second quality of service exceeding the first quality of service.

18. A method comprising:
detecting, by a controller of an earbuds case configured for housing a pair of wireless earbuds, a transition to a connection state in which the pair of wireless earbuds are wirelessly connected to the earbuds case and wirelessly disconnected from a mobile device, the earbuds case including a communication system configured for wireless communication with a wireless network; and
updating a configuration of the communication system to increase a wireless communication capability of the communication system based on the transition to the connection state.

19. The method of claim 18, wherein the wireless network is a Wi-Fi network or a cellular network.

20. The method of claim 18, further comprising:
detecting an additional transition from the connection state to an additional connection state in which the pair of wireless earbuds are wirelessly connected to the mobile device; and
updating the configuration of the communication system to reduce the wireless communication capability of the communication system based on the additional transition to the additional connection state.
